(19) United States
(12) Patent Application Publication
(10) Pub. No.: US 2006/0259920 A1
(43) Pub. Date: Nov. 16, 2006

(54) Streaming voice over protocol

(76) Inventor: Daniel R. Reyes, Carrollton, TX (US)

Correspondence Address: SCHEEF & STONE, L.L.P., 5956 SHERRY LANE, SUITE 1400, DALLAS, TX, 75225, US

(21) Appl. No.: 11/412,229

(22) Filed: Apr. 26, 2006

Related U.S. Application Data
(60) Provisional application No. 60/675,278, filed on Apr. 26, 2005.

(51) Int. Cl. H04N 7/16

(52) U.S. Cl. 725/1

(57) ABSTRACT

Communication path using packet structures linked together to form a communication protocol for communicating a pre-selected set of input and output control and presentation data. The signal protocol is used by link controllers configured to generate, transmit, and receive packets forming the communications protocol, and to form data into one or more types of output packets, a host Key Signature witch will be place into the bios or flash memory device or and being both devices will become host and client to one self to activate call link to a name and routable IP connection being IP-to-IP for route, and UTP-to-UTP being data transfer coupled to a web server for variegation through the communications path. The switchboard interface and hardware support provide a cost-effective, low-power, bi-directional, high-speed data transfer mechanism over the network, being a WAN, wireless WAN, or long-range “Radio” or Satellite type data links, which lend itself to implementation, which are especially useful in connecting audio streaming software over the Internet, WANs, wireless WANs, or long-range “Radio” or Satellite type data links. The invention preferably utilizes software, which is embedded into a Java Chip, BIOS, flash memory, and/or a computer, but not limited for variegation, to enable or disable a box or let an I/O data input or I/O data output communicate with each other or the outside world. Open and Close, Smart Homes, and Talk-back Appliances may be adapted for use with this system and method.

### CROSS-REFERENCE TO RELATED APPLICATIONS

This application claims priority to Provisional Patent Application No. 60/675,278, filed Apr. 26, 2005, entitled “STREAMING VOICE OVER PROTOCOL”, the contents of which are incorporated herein by reference in its entirety.

### TECHNICAL FIELD

The field of the invention is in the field of streaming digital signals, such as video and audio (e.g., voice), in real time over a digital data path and/or protocol, also referred to herein as Streaming Voice Over Protocol (SVoP) communications. More particularly, the invention relates to a system and method of interfacing a standard computer to an SVoP compatible communication network, open/close applications, and also to a digital signal protocol and process for communicating signals between a host communications device and a client communication device at high data rates.

### BACKGROUND

Voice over Internet Protocol (VoIP) allows a computer or electronic part to connect to a network and to act as an alternative to phone lines, delivering real-time voice to both standard telephones and personal computers (PCs). VoIP allows an individual to utilize their computer or electronic part to transmit voice data packets over available local communication lines, such as the Internet, via computer-to-computer, thereby creating a long distance phone call at a local connection price.

Presently, significant voice traffic does not utilize the public Internet, but runs on private IP-based global networks that can deliver voice data with minimal congestion.

Using public telephone lines for long distances calls over the Internet, it will become more and more difficult to maintain real-time voice quality. PSTN are taking back their customers by giving less lines and lesser quality lines to competitors like Vonage and other VoIP companies. In fact, most household computer users are generally limited to implementing the VoIP standard effectively if latency and jitter are too high, or the cost of reducing them is excessive. Security systems over the Internet are currently limited in what they can listen to and view at the same time. Making a video and audio security system over the network will slow significantly when using the standard technology. One alternative is to buffer the CODEC data at the receiver. A large buffer can be filled and used at a uniform rate. This permits good quality reproduction of voice. Such a buffering technique is known as audio streaming. Unfortunately, excessive buffering of the audio signals leads to generally unacceptable one-sided telephone conversations, where one party dominates the transmissions.

Therefore, what is needed is a switchboard interface packetized system that is able to compensate for latency and jitter, without introducing noticeable buffering.

### SUMMARY

Accordingly, the present invention enables traditional soft phone technology to be used with traditional computers in a fixed set of pre-configured applications and a switchboard interface that can handle the input and output from a microphone to the input connection of an “A” computer microphone. And on the other side a switchboard interface handles input and output from the microphone to the input connection of a “B” computer microphone. This will keep a stream at a rate on which will not lose quality. The nominal bandwidth required for telephone type voice ranges from 2.9 Kbps to 13 Kbps.

In a Streaming Voice Over Protocol (SVOP) system, an IP-to-IP connection is made and a UTP-to-UTP is made. A software type call is placed to the host or client system, computer (A) microphone and/or, but not limited, will then feed into the input of the switchboard that will then feed to the output of the switchboard. Next, the output from the switchboard will feed into the computer microphone input connection along with a signal sent out by the switchboard at the time a user starts talking, thereby keeping the soft phone technology from losing signal, echoing, or gaining noise along the way, and signal is then sent back the same way by the client's side. Then, either a software or hardware CODEC performs analog-to-digital or digital-to-analog conversion and frame. The frames are like small bursts of data. One or more frames may be placed in a single User Datagram Protocol (UDP), and then the packet payload is wrapped in suitable packet headers and trailers. The packet overhead is preferably at least 8 bytes for the UDP. Sending a signal with the audio signal through a UDP datagram reduces overall overhead, which in turn reduces the true bandwidth needed to send the digitized voice. The switchboard interface on the client's side can send voice data to the host side at the same time making this the ideal method for reducing excessive latency and jitter.

A data interface is provided for transferring digital data between a host-client and a client-host over a communication path using packet structures linked together to form a communication protocol for communicating a pre-selected set of digital control and presentation data. The signal protocol is used by link controllers configured to generate, transmit, and receive packets forming the communications protocol, and to form digital data into one or more types of data packets, a host key signature which will be placed into a BIOS or flash memory device and being both devices will become host and client to one self to activate call link to a name and routable IP connection being IP-to-IP for route and UTP-to-UTP and SLIP-to-SLIP being data transfer coupled to the server through the communications path. The interface provides a cost-effective, low-power, bi-directional, high-speed data transfer mechanism over a network, such as a Wide Area Networks (WANs), wireless-WANs, long-range “Radio” or Satellite, or the like.

A system and method is disclosed herein for forming a secure audio system circuitry connections within an input/output (I/O) interface for transferring data between a Point A host-client and Point B client-hosts over a communication path in a self-bootable auto-configurable unit. This reduces the noise of sending digitized voice over a LAN, WAN or wireless configuration, and avoid latency and jitter at the source, and too much total latency results in poor communication and a difficult conversation.

A switching module is in electrical communication with the application software and is operable to perform switching functions to effect the end-to-end switching requests from the application software, the switching module compressing a switch and a configuration table data base in which a key signature is translated into a second key signature to determine the connection of the data inputs and data outputs to the switch.

One advantage of the invention is to be able to use soft phone technology to create a voice call over the Internet.

Another advantage of the invention is to provide a method and system that facilitates long-range wireless telephone functionality between a handset and a base station, while maintaining data connection.

A further advantage of the invention is the ability to provide a packetized system that is able to compensate for latency and jitter, without introducing noticeable buffering delays or echo's.

It is yet another advantage of the present invention to provide a system that integrates a security system audio and video sensors driving monitor host to client station with self-boot and self-configuring unit, thereby releasing the requirement that the user using the device as.

Another advantage of the invention is transmission of various digitally reproduced audio signals to a remote appliance, giving it commands through mains of input/output, on/off, yes/no, keyboard, mouse or voice recognition.

It is yet another advantage of the invention to provide a system that integrates one or more telephone handsets in a pay-per-use long distant setup.

The above and other advantages of the invention are satisfied at least in part by providing interface circuitry and software on or between Point A to Point B network computers.

The objects and advantages of the invention may be realized and obtained by means of the instruments and combinations particularly pointed out in the appended claims. These and other objects and features of the present invention will become more fully apparent from the following description and appended claims, or may be learned by the practice of the invention as set forth hereinafter.

The foregoing has outlined rather broadly the features and technical advantages of the present invention in order that the detailed description of the invention that follows may be better understood. Additional features and advantages of the invention will be described hereinafter which form the subject of the claims of the invention. It should be appreciated by those skilled in the art that the conception and the specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

In order that the manner in which the above recited and other advantages and objects of the invention may be obtained, a more particular description of the invention briefly described above will be rendered by reference to specific embodiments thereof, which are illustrated, in the appended drawings. Understanding that these drawings depict only typical embodiments of the invention and are not therefore to be considered to be limiting of its scope, the invention will be described and explained with additional specificity and detail through the use of the accompanying drawings and appendices in which:

FIG. 1 is a perspective view exemplifying an H-Client;

FIG. 2 exemplifies dimensions of the H-Client of FIG. 1;

FIG. 3 is a perspective view exemplifying a C-Host;

FIG. 4 exemplifies dimensions of the C-Host of FIG. 3;

FIG. 5 illustrates an exemplary system that provides a suitable operating environment for the present invention;

FIG. 6 illustrates a further exemplary system that provides an interface connector between a household appliance and an H-Client (PyramidX);

FIG. 7 is a flow chart illustrating control logic for implementing a call using an interface embodying features of the present invention;

FIG. 8 is a flow chart illustrating control logic for implementing a video connection using an interface embodying features of the present invention;

FIG. 9 is a flow chart illustrating control logic for implementing a voice connection using an interface embodying features of the present invention;

FIG. 10 is a flow chart illustrating control logic for implementing a sensor connection using an interface embodying features of the present invention;

FIGS. 11A, 11B, 11C, and 11D exemplify interaction between a domain server and/or a remote monitoring service embodying features of the present invention;

FIG. 12 depicts a schematic diagram embodying features of the present invention;

APPENDIX A exemplifies key signature code for a code server;

APPENDIX B exemplifies switchboard control code for a code server;

APPENDIX C exemplifies key signature code for a code client; and

APPENDIX D exemplifies switchboard control code for a code client.

### DETAILED DESCRIPTION

In the following discussion, numerous specific details are set forth to provide a thorough understanding of the present invention. However, it will be obvious to those skilled in the art that the present invention may be practiced without such specific details. In other instances, well-known elements have been illustrated in schematic or block diagram form in order not to obscure the present invention in unnecessary detail. Additionally, for the most part, details concerning communication protocols and the like have been omitted inasmuch as such details are not considered necessary to obtain a complete understanding of the present invention, and are considered to be within the skills of persons of ordinary skill in the relevant art.

It is noted that, unless indicated otherwise, all functions described herein may be performed by a processor such as a microprocessor, a controller, a microcontroller, an application-specific integrated circuit (ASIC), an electronic data processor, a computer, or the like, in accordance with code, such as program code, software, integrated circuits, and/or the like that are coded to perform such functions. Furthermore, it is considered that the design, development, and implementation details of all such code would be apparent to a person having ordinary skill in the art based upon a review of the present description of the invention.

The invention is described below using diagrams to illustrate either the structure or the processing of embodiments used to implement the systems and methods of the present invention. Using the diagrams in this manner to present the invention should not be construed as limiting of its scope. The present invention contemplates both methods and systems. The invention may be practiced in network computing environments with many types of computer system configurations, including personal computers, handheld devices, multi-processor systems, microprocessor-based or programmable consumer electronics, network PCs, minicomputers, mainframe computers, Personal Digital Assistants (PDAs), and the like. The invention may also be practiced in distributed computing environments where local and remote processing devices perform tasks that are linked (either by hardwired links, wireless links, or by a combination of hardwired or wireless links) through a communications network. In a distributed computing environment, program modules may be located in both local and remote memory storage devices.

A data interface for transferring digital data between a host-client and a client-host over a communication path using packet structures linked together to form a communication protocol for communicating a per-selected set of digital control and presentation data.

The video interface may use a standard SVGA monitor, S-video, RCA connection, or the like.

The present invention preferably uses software, RMS (Remote Monitoring Service) and/or embedded Hard drive, but is not limited for variegation to enable or disable the H-client or the C-host or let an I/O data input or I/O data output communicate with each other or the outside world.

In the near future, software will preferably be embedded in a BIOS, Java chip, flash memory, RMS (Remote Monitoring Service) and/or embedded in a hard drive, but not limited for variegation to enable or disable an H-client or C-host or let an I/O data input or I/O data output communicate with each other or the outside world.

A traditional analog telephone may be used with this application. By way of example, but not limitation, a data interface link may be established for transferring digital data between a C-host and an H-client communication protocol for communicating, and then connect a standard telephone or cordless telephone to this device.

A switching module in electrical communication with the application software and operable to perform switching functions to effect end-to-end switching requests from the application software, the switching module compressing a switch and a configuration table database in which one key signature is translated into a second key signature to determine the connection of the data inputs and data outputs to the switch.

Using the diagrams in this manner to present the invention should not be construed as limiting of its scope. The invention may comprise a special purpose or general-purpose computer, including various computer hardware configurations, as discussed in greater detail below. Embodiments within the scope of the present invention also include computer-readable media for carrying or having computer-executable instructions or data structures stored thereon. Such computer readable media may comprise any available media that may be accessed by a general purpose or special purpose computer. By way of example, and not limitation, such computer-readable media may comprise RAM, ROM, EEPROM, CD-ROM or other optical disk storage, magnetic disk storage or other magnetic storage devices, or any other medium which can be used to carry or store desired program code means in the form of computer-executable instructions or data structures and which can be accessed by a general purpose or special purpose computer. When information is transferred or provided over a network or another communications connection (either hardwired, wireless, or a combination of hardwired or wireless) to a computer, the computer properly views the connection as a computer-readable medium. Thus, any such connection is properly termed a computer-readable medium. Combinations of the above should also be included within the scope of computer-readable media. Computer-executable instructions comprise, for example, instructions and data which cause a general purpose computer, special purpose computer, or special purpose processing device to perform a certain function or group of functions.

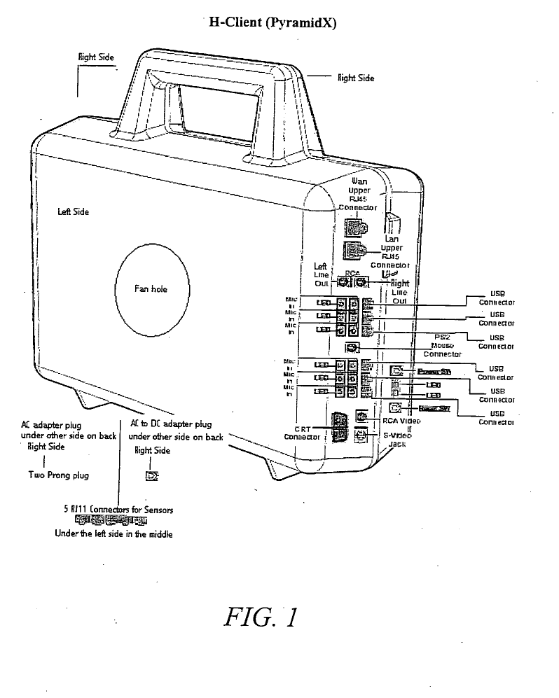

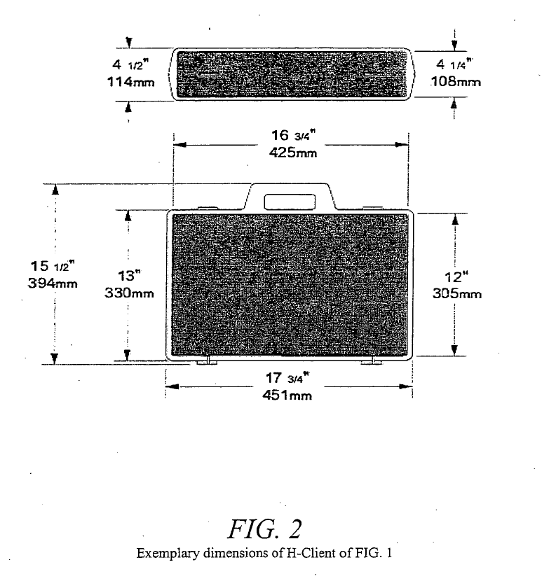

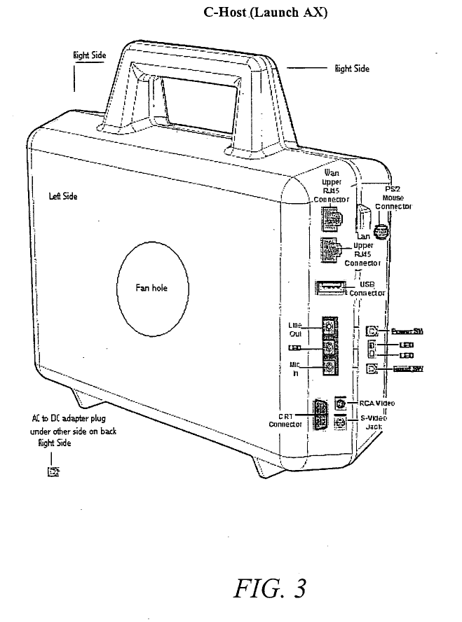

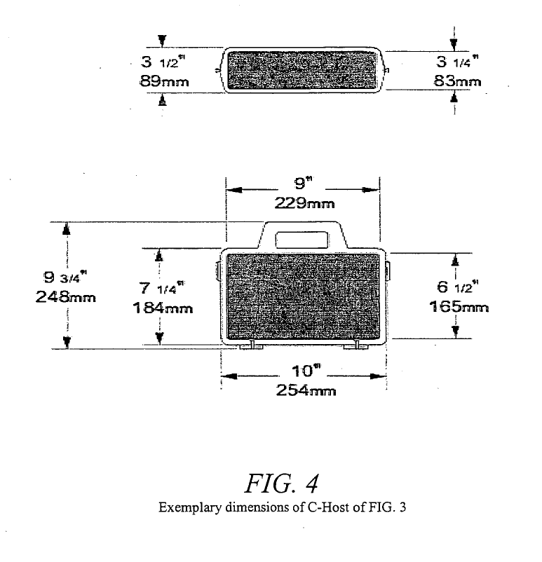

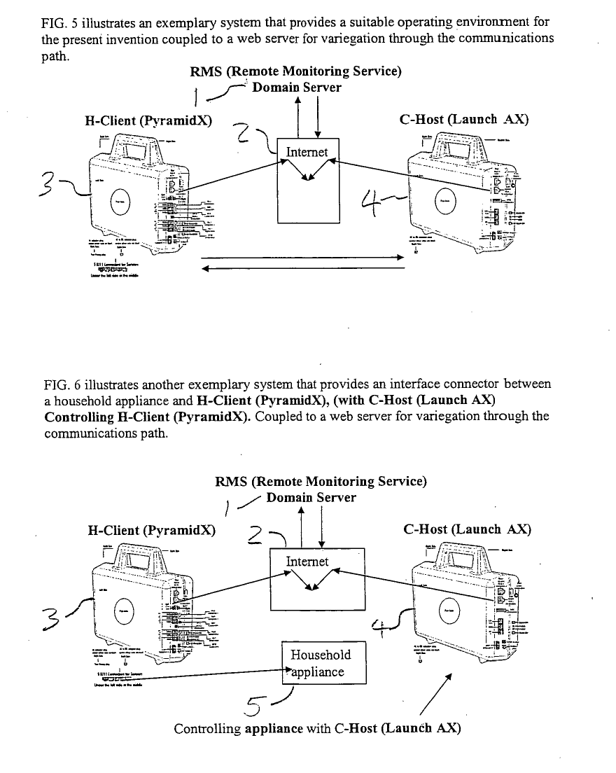

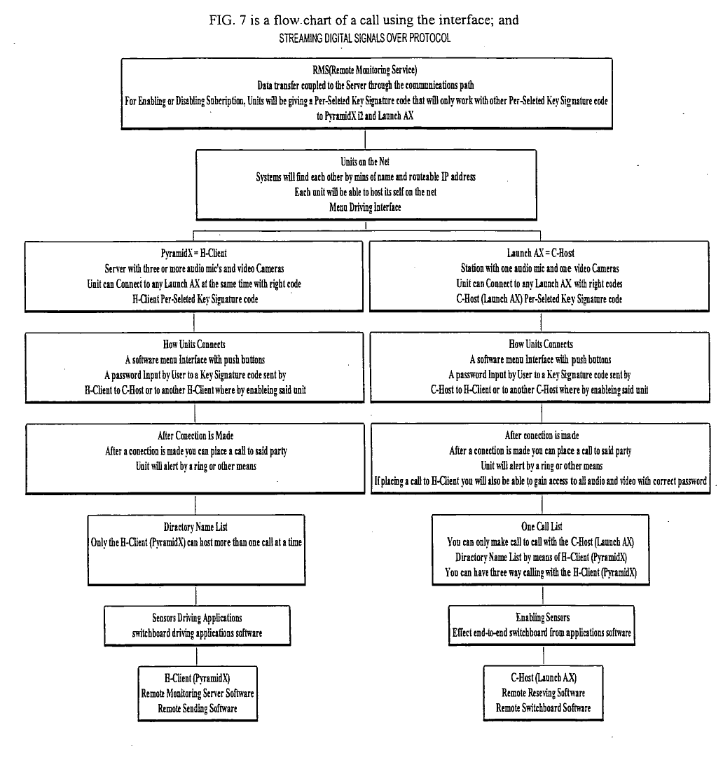

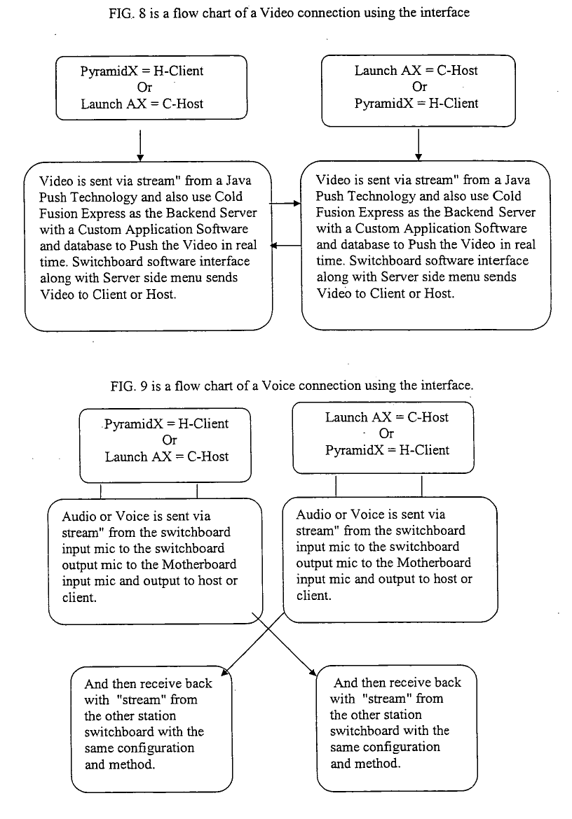

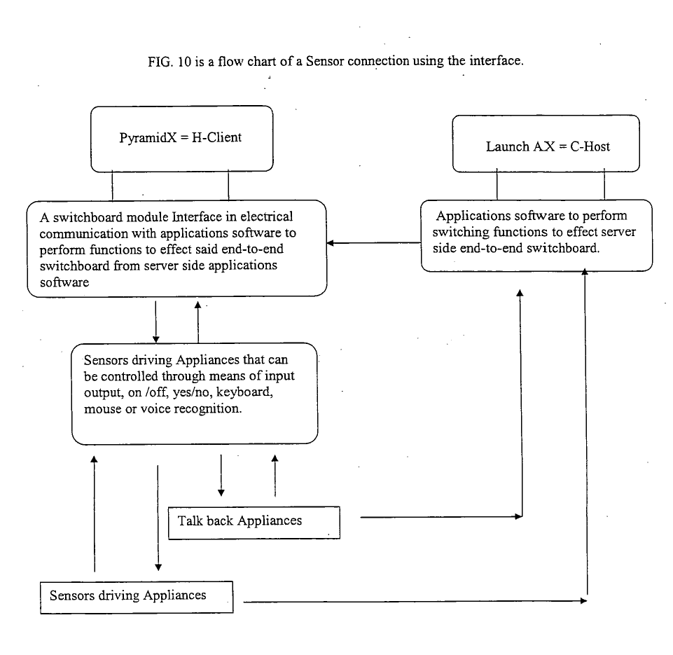

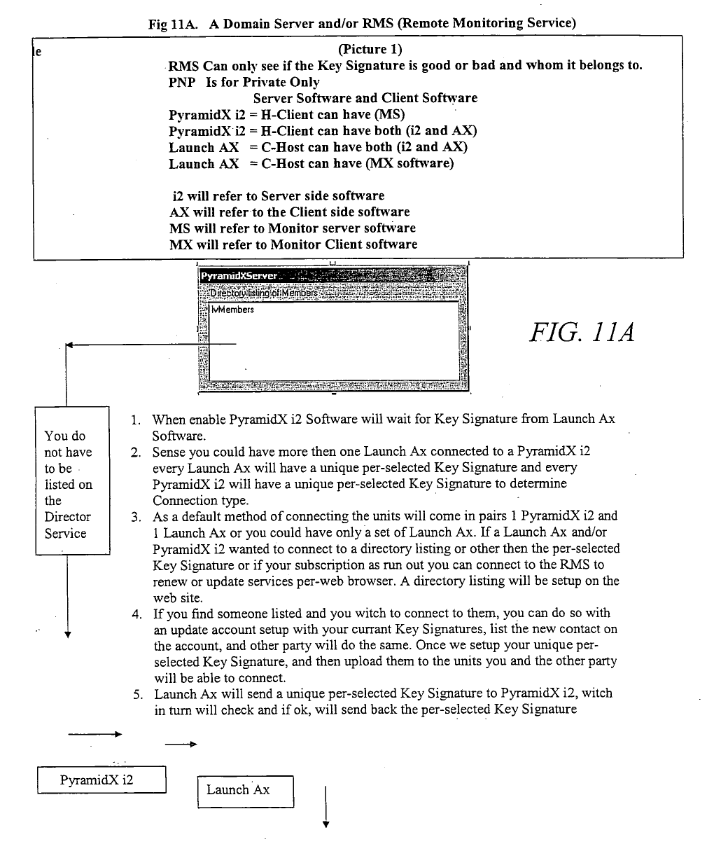

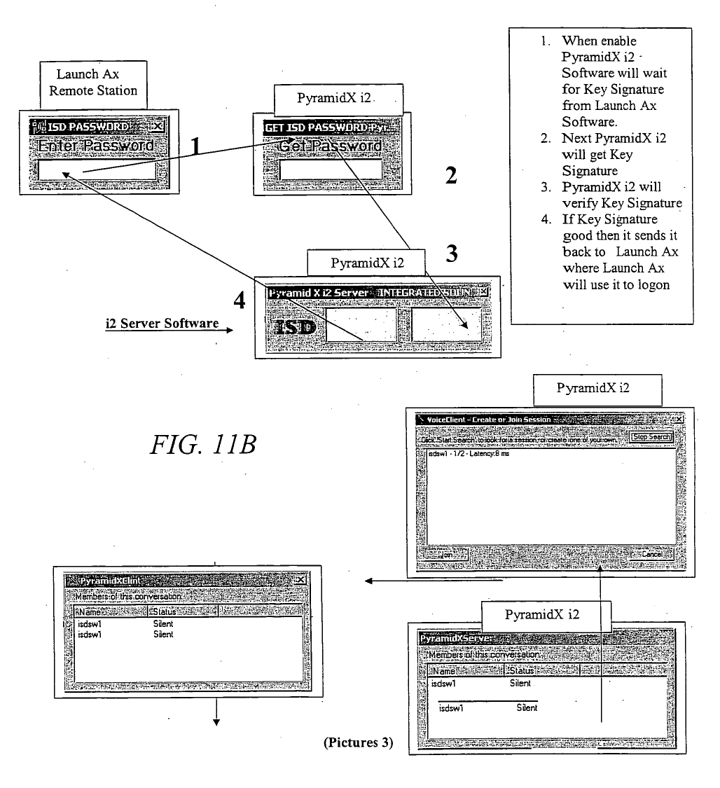

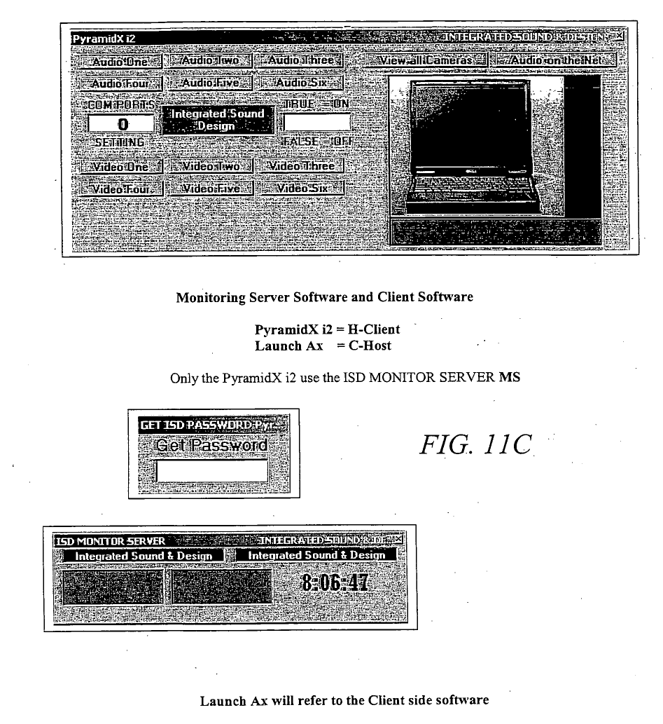

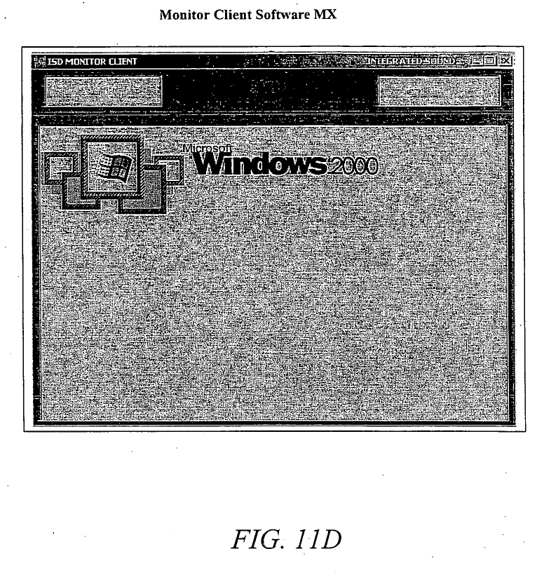

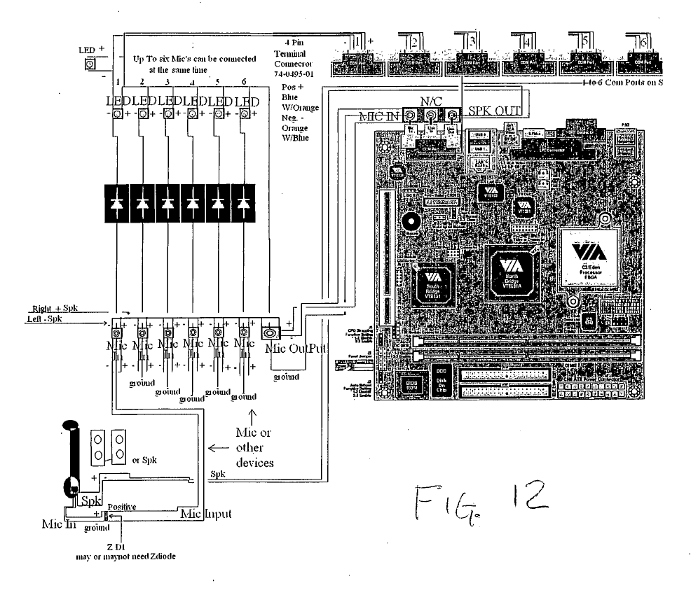

FIG. 1 and the following discussion are intended to provide a brief, general description of a suitable computing environment in which the invention may be implemented. The invention will be described in the general context of computer-executable instructions, such as program modules, being executed by computers in network environments. Generally, program modules include routines, programs, objects, components, data structures, and the like, that perform particular tasks or implement particular abstract data types. Computer-executable instructions, associated data structures, and program modules represent examples of the program code means for executing steps of the methods disclosed herein. The particular sequences of such executable instructions or associated data structures represent examples of corresponding acts for implementing the functions described in such steps. Multi-processor systems, microprocessor-based or programmable consumer electronics, network PCs, minicomputers, mainframe computers, personal digital assistants (PDAs), and the like. The invention may also be practiced in distributed computing environments where local and remote processing devices perform tasks that are linked (either by hardwired links, wireless links, or by a combination of hardwired or wireless links) through a communications network. In a distributed network computing environment (e.g., a WAN), program modules may be located in both local and remote memory storage devices.

With reference to FIG. 5, an exemplary system for implementing the invention includes a computing device in the form of a Domain Server 1, a communications network, such as the Internet, 2, an H-Client computer 3, and a C-Host computer 4 that couples various system components including the system memory to the processing unit. While not shown, each computer 3 and 4 further includes switchboard and interface connected to the communications network 2.

As shown in FIG. 5, a domain server and/or RMS (Remote Monitoring Service) can only see if the key signature is good or bad and who it belongs to. It will be used as one way of a number of different ways available to connect devices. One or more devices will be enabled to connect with each other on the Web or through proxy and/or firewalls and being both devices.

Connection of a Client-Host (also referred to herein as a C-Host or Launch AX) with a Host-Client (also referred to herein as an H-Client, PyramidX, or PyramidX i2) is exemplified herein by having one unit in a Dallas, Tex. office, and wherein a PyramidX i2 is monitoring six audios, and six video cameras, and is always connected to the Internet and has been verified by the RMS or a PyramidX i2 that has a one year PNP (Private Network Portal). A sales manager next travels to a neighboring country for a meeting, and takes along a Launch AX. At the meeting, he gives a demonstration of a product to show to his partner. Back at a hotel, he decides he would like to show his partner the product before he leaves the country, but does not know how. His picture phone does not work in this area and a long distant call will cost to much and, furthermore, will not include video. The is a moveable demo. He sees an Internet coffee shop at the corner by the hotel. He buys a cup of coffee and connects wirelessly to the Internet without knowing it the (RMS, Picture 1) or (PNP Picture 1) as verified his subscription. He calls, a ring or announcement alerts his partner, and then his partner will answer the incoming call by a handset, speaker-phone or/but not limited too, (Picture 3) If he wanted to see a live demo. (Picture 3).

Although the exemplary environment described herein employs a magnetic hard disk, other types of computer readable media for storing data can be used, including magnetic cassettes flash memory cards, digital video disks, Bernoulli cartridges, magnetic tapes, RAMs, ROMs, and the like. Program code means comprising one or more program modules may be stored on the hard disk, magnetic disk, optical disk, ROM or RAM including an operating system, and one or more application programs and other program modules and program data. A user may enter commands and information into the computer through a keyboard, pointing device, PDA cradle, or other input device (not shown), such as a microphone, joy stick, game pad, digital camera, satellite dish, scanner, or the like. These and other input devices are often connected to the processing unit through a serial port interface coupled to a system bus. Alternatively, the input devices may be connected by other interfaces, such as a parallel port, a serial port, an infra-red (IR) port, a short-range wireless port, an RF port, Blue tooth, a game port, or a universal serial bus (USB).

Program modules depicted relative to the computer, or portions thereof, may be stored in the remote memory storage device. It will be appreciated that the network connections shown are exemplary, and other means of establishing communications over a WAN may be used.

In addition to the foregoing discussion and description, details of one preferred embodiment of the present invention are further described and disclosed in Appendices A (entitled Code Server, Key Signature Code), B (entitled Code Server, Switchboard Control Code), C (entitled Code Client, Key Signature Code), and D (entitled Code Client, Switchboard Control Code), which are attached herewith and hereby incorporated by reference. The code shown is written in Visual Basic 5.0. It is understood that the Appendices exemplify, without limitation, one preferred embodiment of code that may be used to implement the present invention. It is further understood that any of a number of conventional pre-configured soft phone technologies and code may be used and/or written to supplement the code embodied in the Appendices for a signal interface to a particular port.

By the use of the present invention, a number of applications may be utilized with the invention including, by way of example but not limitation, (1) a Security Station connected to sensors controlled by a custom Remote Monitoring Software, key interface software switching module and/or switchboard interface Servers, (2) Security Company's monitoring their Clients, (3) Call to Call, (4) Conference Calls, and (5) sensor driving appliances that may be controlled through mains of input/output, on/off, yes/no, keyboard, mouse or voice recognition. For example, with respect sensor driving appliances, a knock at a door will alert the device that someone is at the door and a pre-selected voice model will first let a user know that he/she has a visitor and will wait for a response from the user. The user's response may be input or voice-driven, and will then give the device it's next job of letting the visitor know someone is coming, or that no one is home and can then take a video voice message, or the user can answer the door from a neighboring door, or wherever the user is at the time.

Having thus described the present invention by reference to certain of its preferred embodiments, it is noted that the embodiments disclosed are illustrative rather than limiting in nature and that a wide range of variations, modifications, changes, and substitutions are contemplated in the foregoing disclosure and, in some instances, some features of the present invention may be employed without a corresponding use of the other features. Many such variations and modifications may be considered obvious and desirable by those skilled in the art based upon a review of the foregoing description of preferred embodiments. Accordingly, it is appropriate that the appended claims be construed broadly and in a manner consistent with the scope of the invention.

1. A system for streaming digital signals over protocol, comprising:
a communications network;
a host computer having a host switchboard and interface connected to said communications network;
a client computer having a client switchboard and interface connected to said communications network for data communications with said host computer;
computer program code executable by said host computer for switching functions to effect said end-to-end communications between the host switchboard and the client switchboard.

2. The system of claim 1 further comprising computer program code for performing functions to effect said end-to-end communications between said host switchboard and the client switchboard.

3. The system of claim 2 further comprising a switch and a configuration in which a signal is sent into said client switchboard to effectuate data communications between Point A and Point B to determine the connection of said data inputs and data outputs to said host switchboard.

4. The system of claim 2 further comprising:
computer program code executable for streaming audio from the host switchboard input microphone connection to the client switchboard microphone output connection;
an output connection from the host switchboard to the input connection of the motherboard microphone input connection;
the input from the microphone connection is then sent via LAN, WAN or wireless to host or client; and
computer program code for receiving back with “stream” from the other station switchboard with the same configuration and method.

5. The system of claim 2 further comprising:
computer program code for streaming voice from the host switchboard input microphone connection to the client switchboard microphone output connection;
an output connection from the switchboard to the input connection of the motherboard microphone input connection;
computer program code for sending input from the microphone connection via LAN, WAN, or wireless to said host computer or said client computer; and
receiving back with “stream” from the client switchboard with the same configuration and method.

6. The system of claim 2 configured for providing a bi-directional, high-speed data link, which can be used to transfer audio, voice or video effectively “stream” from a first CODEC being on the unit which made a call to a second CODEC being on the unit which will receive the call, and then sent back with “stream” from the first CODEC being on the unit which received the call to the second CODEC being on the unit which made the call.

7. The system of claim 2 further comprising an on/off switch operable via remote control.

8. The system of claim 2 further The total network latency and jitter (changes in the latency) do not have a degrading effect upon voice quality. Therefore, real-time voice quality is maintained over a large wide-area network.

9. The system of claim 2 configured for reducing the noise of sending digitized voice over a LAN, WAN or wireless configuration. An echo canceller

10. The system of claim 2 configured for reducing the noise of sending digitized voice over a LAN, WAN or wireless configuration by utilizing an echo canceller.

11. The system of claim 2 further comprising:
computer program code for placing a call to the host computer or client computer;
host computer microphone effective for feeding into the input of the host switchboard that will then feed to the output of the switchboard;
computer program code for feeding output from the host switchboard into the computer microphone input connection along with a signal sent out by the host switchboard by means of a LAN, WAN or wireless networks at the time a user starts talking, to thereby keep the soft phone technology from losing signal along the way;
computer program code for compensating for latency and jitter, without introducing noticeable buffering delays or echo's; and
computer program code for sending the signal back the same way by the client's computer.
